(19) United States
(12) Patent Application Publication
(10) Pub. No.: US 2024/0288890 A1
(43) Pub. Date: Aug. 29, 2024

(54) BANDGAP REFERENCE CIRCUIT

(71) Applicant: Texas Instruments Incorporated, Dallas, TX (US)

(72) Inventors: Sowmya Sankaranarayanan, Tucson, AZ (US); Orlando Lazaro, Cary, NC (US); Kevin Scoones, San Jose, CA (US); Avinash Bhat

(73) Assignee: Texas Instruments Incorporated, Dallas, TX (US)

(21) Appl. No.: 18/173,144

(22) Filed: Feb. 23, 2023

(51) Int. Cl. G05F 1/46; G05F 1/575; G05F 3/30

(52) U.S. Cl. CPC G05F 1/465; G05F 1/575; G05F 3/30

(57) ABSTRACT

In one example, an apparatus comprises a voltage reference circuit. The voltage reference circuit has a voltage reference terminal and includes a first circuit, a first semiconductor junction device, and a second semiconductor junction device coupled between the voltage reference terminal and a ground terminal. The first circuit is configured to generate a first voltage that increases with a temperature. The first semiconductor junction device is configured to generate a second voltage that decreases with the temperature. The second semiconductor junction device is configured to generate a third voltage that decreases with the temperature. The voltage reference circuit is configured to generate a fourth voltage between the voltage reference terminal and the ground terminal based on a sum of the first voltage and a combination of the second and third voltages.

### BACKGROUND

A voltage reference circuit can provide a voltage that can be used as a reference for comparison with another voltage. There are many applications for voltage reference circuit. For example, a controller may control a power converter (or a voltage regulator) to regulate an output voltage at a target voltage level, and a controller may generate a control signal for the power converter by comparing the output voltage (or a scaled down version of it) with a reference voltage provided by the voltage reference circuit. As another example, an analog-to-digital converter can generate a digital representation of a voltage by comparing the voltage with one or more reference voltages. To reduce the variation of the reference voltage with respect to temperature, supply voltage, and process variations, the voltage reference circuit may include a bandgap circuit to generate the reference voltage.

### SUMMARY

In one example, an apparatus comprises a voltage reference circuit. The voltage reference circuit has a voltage reference terminal and includes a first circuit, a first semiconductor junction device, and a second semiconductor junction device coupled between the voltage reference terminal and a ground terminal. The first circuit is configured to generate a first voltage that increases with a temperature. The first semiconductor junction device is configured to generate a second voltage that decreases with the temperature. The second semiconductor junction device is configured to generate a third voltage that decreases with the temperature. The voltage reference circuit is configured to generate a fourth voltage between the voltage reference terminal and the ground terminal based on a sum of the first voltage and a combination of the second and third voltages.

### BRIEF DESCRIPTION OF THE DRAWINGS

FIG. 1 is a block diagram of a circuit that includes an example bandgap reference circuit.

FIGS. 2A, 2B, and 2C are schematics of an example bandgap reference circuit and its operation.

FIG. 3 are graphs illustrating example distribution of reference voltage provided by the example bandgap reference circuit of FIG. 2A.

FIG. 4, FIG. 5, FIG. 6A, and FIG. 6B are schematics of example bandgap reference circuit.

FIG. 7, FIG. 8, FIG. 9, and FIG. 10 are schematics of example internal components of bandgap reference circuit.

FIG. 11, FIG. 12, and FIG. 13 are schematics of example band reference circuits.

FIG. 14 and FIG. 15 are graphs illustrating example distribution of reference voltage provided by the example bandgap reference circuit of FIGS. 4-13.

The same reference numbers or other reference designators are used in the drawings to designate the same or similar (either by function and/or structure) features.

### DETAILED DESCRIPTION

The following description provides different examples for implementing features of the provided subject matter. Specific examples of components and arrangements are described below to simplify the present description. The drawings are not drawn to scale.

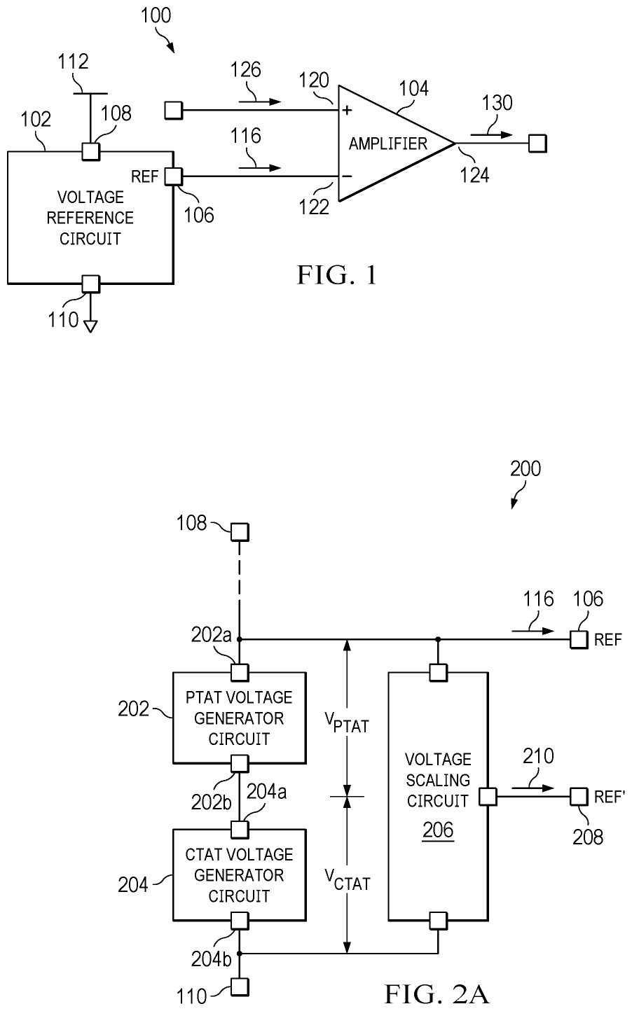

FIG. 1 illustrates an example of a system 100 including a voltage reference circuit 102 and an amplifier 104. Voltage reference circuit 102 can have a reference voltage output 106, a power supply terminal 108, and a ground terminal 110. Power supply terminal 108 can be coupled to a power source 112 (e.g., a power converter) that supplies power (including a voltage and a current) to voltage reference circuit 102, and ground terminal 110 can be coupled to ground. Voltage reference circuit 102 can receive power from power source 112 and generate a reference voltage 116 at reference voltage output 106.

Amplifier 104 can have a first input 120 (e.g., a positive input), a second input 122 (e.g., a negative input), and an amplifier output 124. In some examples, amplifier 104 can be a comparator. Second input 122 is coupled to reference voltage output 106. Amplifier 104 can also receive power from power source 112 can receive a voltage 126 at first input 120 and reference voltage 118 at second input 122, and provide a signal 130 at amplifier output 124 representing a comparison between voltage 126 and reference voltage 118. For example, in a case where amplifier 104 is a comparator, if voltage 126 exceeds reference voltage 118, amplifier 104 can provide signal 130 having an asserted state. Also, if voltage 126 is below reference voltage 118, amplifier 104 can provide signal 130 having a de-asserted state. In some examples, amplifier 104 can also provide signal 130 indicating a difference between voltage 126 and reference voltage 118 and whether voltage 126 is below or above reference voltage 118.

System 100 can be part of various circuits, such as a power converter/voltage regulator and an analog-to-digital converter (ADC). For example, in a case where system 100 is part of a power converter (or a voltage regulator), voltage 126 can be an output voltage of the power converter (or a scaled down version of it), and reference voltage 116 can represent a target output voltage of the power converter. Output signal 130 can provide a control signal to the power converter to reduce/minimize the difference between the output voltage and the target. As another example, in a case where system 100 is part of an ADC, voltage 126 can be an analog voltage to be digitized, reference voltage 116 can represent a comparison reference, and output signal 130 can provide a digital representation of voltage 126 (e.g., a bit indicating whether voltage 126 exceeds reference voltage 116).

For various reasons, voltage reference circuit 102 may introduce variations in reference voltage 116. For example, voltage reference circuit 102 may derive reference voltage 116 from the voltage provided by power source 112. Voltage reference circuit 102 may introduce variations in reference voltage 116 due to variations in the voltage provided by power source 112. Also, various device characteristics, such as various voltage-current characteristics of transistor devices, also vary due to temperature and process variations, all of which can introduce variation in reference voltage 116. Because of all these variations, reference voltage 116 can deviate from its target/intended voltage, which can affect the performance of the circuit that uses reference voltage 116.

In some examples, voltage reference circuit 102 can include a bandgap reference circuit to reduce the variations of reference voltage 116. A bandgap reference circuit can include circuits that generate voltages having opposite dependencies on temperature. The bandgap reference circuit can generate a reference voltage (e.g., reference voltage 116) based on a sum of the voltages. The opposite dependencies on temperature can cancel or attenuate each other in the sum, which can reduce the variation of the reference voltage with temperature. Also, the bandgap reference circuit can generate the reference voltage with reference to the ground terminal having a voltage of, for example, 0 V, which can reduce the variation of the reference voltage due to power supply voltage variation.

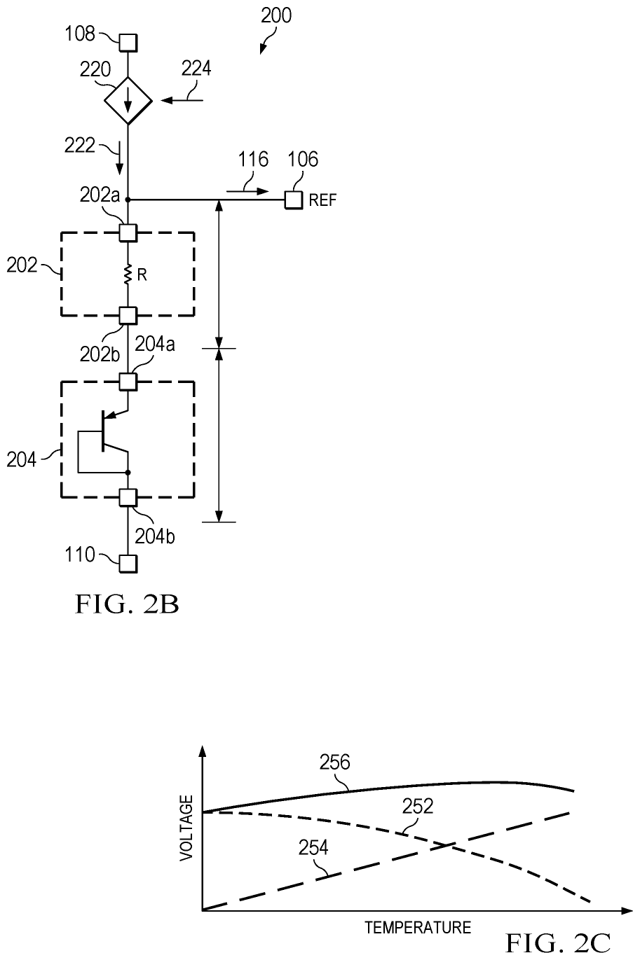

FIGS. 2A and 2B illustrate examples of bandgap reference circuit 200 that can be part of voltage reference circuit 102. Referring to FIG. 2A, bandgap reference circuit 200 can include a proportional to absolute temperature (PTAT) voltage generator circuit 202 and a complementary to absolute temperature (CTAT) voltage generator circuit 204 coupled between reference voltage output 106 and ground terminal 110. PTAT voltage generator circuit 202 and CTAT voltage generator circuit 204 can be arranged in any order between reference voltage output 106 and ground terminal 110, and FIG. 2A illustrates one example order. PTAT voltage generator circuit 202 has terminals 202a and 202b. PTAT voltage generator circuit 202 can generate a voltage V_{PTAT} across terminals 202a and 202b, where V_{PTAT} can increase with temperature. Also, CTAT voltage generator circuit 204 has terminals 204a and 204b. CTAT voltage generator circuit 204 can generate a voltage V_{CTAT} across terminals 204a and 204b, in which V_{CTAT} can decrease with temperature. PTAT voltage generator circuit 202 and CTAT voltage generator circuit 204 can be coupled in series so that the same current flows through both circuits, and bandgap reference circuit 200 can generate reference voltage 116 between reference voltage output 106 and ground terminal 110 based on a sum of V_{PTAT} and V_{CTAT}. Because V_{PTAT} and V_{CTAT} have opposite dependencies with respect to temperature, the dependency of the sum of V_{PTAT} and V_{CTAT} on temperature can be reduced, which can reduce the variation of reference voltage 126 with respect to temperature. In some examples, bandgap reference circuit 200 can include a voltage scaling circuit 206 coupled between reference voltage output 106 and a second reference voltage output 208. Voltage scaling circuit 206 can include a voltage divider circuit or a voltage multiplier circuit, and can generate another reference voltage 210 at second reference voltage output 208 by dividing down or multiply reference voltage 126. Because reference voltage 116 has reduced dependence on temperature, reference voltage 210 can also have reduced dependence on temperature.

FIG. 2B illustrates example internal components of bandgap reference circuit 200. Referring to FIG. 2B, PTAT voltage generator circuit 202 can include a resistor having a resistance R coupled between terminals 202a and 202b. Bandgap reference circuit 200 can include a variable current source 220 to supply a current 222 to the resistor and to generate the voltage V_{PTAT} based on a product of current 222 and the resistance R.

Variable current source 220 can receive a control signal 224 to adjust current 222, so that current 222 can be a PTAT current and increases with temperature, and that the voltage V_{PTAT} can also increase with temperature. As to be described below, bandgap reference circuit 200 can include a current control feedback loop that senses the V_{CTAT} voltage difference between two CTAT devices that have different current densities, and the V_{CTAT} voltage difference is a function of a thermal voltage V_{T} that increases with temperature. The current control feedback loop can adjust control signal 224 based on the sensed V_{CTAT} voltage difference to generate a PTAT current.

Also, CTAT voltage generator circuit 204 can include a semiconductor junction (e.g., a PN junction, a semiconductor-metal junction, etc.) coupled between terminals 204a and 204b. The semiconductor junction can be part of a diode, or a diode-connected transistor. In the example of FIG. 2B, CTAT voltage generator circuit 204 can include a diode-connected PNP bipolar junction transistor (BJT), with base and collector coupled together to form a cathode, and the emitter forms an anode. The V_{CTAT} voltage across CTAT voltage generator circuit 204 when conducting current 222 can be based on the forward voltage of a diode or a threshold V_{BE} voltage to turn on the diode-connected BJT. Both the forward voltage and the threshold V_{BE} voltage can have a negative temperature coefficient and can decrease as temperature increases.

FIG. 2C includes represent example variations of, respectively V_{PTAT}, V_{CTAT}, and reference voltage 116 of FIG. 2A. In FIG. 2C, graph 252 represents an example variation of the V_{CTAT} voltage with respect to temperature, graph 254 represents an example variation of the V_{PTAT} voltage with respect to temperature, and graph 256 represents an example variation of reference voltage 116 with respect to temperature. As shown in FIG. 2C, the voltage V_{PTAT} increases with temperature, and the V_{CTAT} voltage decreases with the temperature. Because of the opposite dependencies on temperature between the voltages V_{PTAT} and V_{CTAT}, reference voltage 116, which is based on a sum of the voltages V_{PTAT} and V_{CTAT}, can have reduced dependency on temperature compared with each of the voltages V_{PTAT} and V_{CTAT}.

Although the example bandgap reference circuit 200 of FIG. 2A-2B can reduce the dependence of reference voltage 116 on temperature and power supply voltage, reference voltage 116 may still vary considerably due to process variations. Specifically, due to tolerance in fabrication (e.g., placement of masks, control of implantation process, etc.), there can be variations in doping concentrations and/or geometries of a semiconductor junction between two different integrated circuits (ICs), and the variations in doping concentrations and geometries can introduce variations in the forward voltage (of a diode) or the threshold V_{BE} voltage (of a BJT) of CTAT voltage generator circuit 204 between different ICs. For example, the amount of current ID conducted by a diode can be related to the voltage across the diode V_{D} based on the following equations:

$${I}_{D} = {I}_{S} ( {e}^{{qV}_{D} / kT} - 1 ) \qquad ( Equation 1 )$$

$${I}_{S} = {qAn}_{i}^{2} ( \frac{{D}_{N}}{{L}_{N} {N}_{A}} + \frac{{D}_{P}}{{L}_{P} {N}_{D}} ) \qquad ( Equation 2 )$$

In Equations 1 and 2, I_{S} represents the saturation current, q represents the elementary charge constant, k represents the Boltzmann's constant, T represents the absolute temperature, and nᵢ is the intrinsic carrier density. The parameters q, k, and T are not affected by process variations. Also, N_{A} and N_{D}, are the density of acceptor and donor ions and represent the doping concentrations. D_{N} and D_{P}, are the diffusion coefficients for N- and P-type doped regions, respectively, and they vary with doping concentration. Also, L_{N} and L_{P} are the average recombination distances for N-type and P-type doped regions, respectively, and they vary with doping concentration. Further, A is the cross-sectional area of the p-n junction and it varies with geometry of the device.

The forward voltage (or V_{BE}) can be based on the threshold diode voltage V_{D} for which the diode current exceeds zero, which can be based on process-dependent parameters such as N_{A} and N_{D}, D_{N} and D_{P}, L_{N} and L_{P}, and A. Because these parameters can vary between different ICs due to the process variations, the V_{CTAT} voltage may also vary between different ICs. On the other hand, as to be described below, the V_{PTAT} voltage can be generated based on a difference between two forward voltages (or two V_{BE}) of two correlated transistors/diodes. The process-dependent variation of the forward voltage/V_{BE} can be cancelled out (or at least attenuated) in the difference, which can reduce the V_{PTAT} voltage variation between different ICs. Accordingly, the variation of reference voltage 116 can be mostly contributed by the variations in the V_{CTAT} voltage, which can be reduced using techniques to be described below.

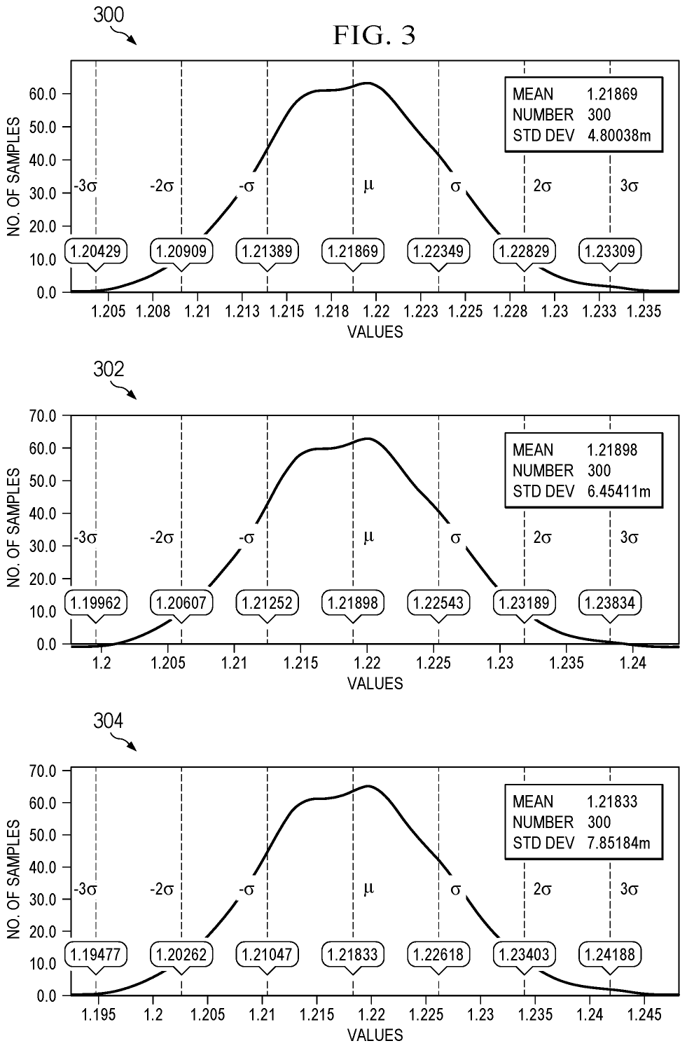

FIG. 3 includes graphs representing example distributions of reference voltage 116 provided by the example bandgap reference circuit 200 of FIG. 2A with random process variations. Graphs 300, 302 and 304 illustrate example distributions of reference voltage 116 with bandgap reference circuit 200 operating at, respectively, −40° C., 27° C., and 85° C. Graphs 300, 302 and 304 are obtained from simulation of three hundred instances of bandgap reference circuit 200. The following table provides a summary of the mean and standard deviation of reference voltage 116 for each temperature. The standard deviation is between 0.4%-0.6% of the mean reference voltage 116.

TABLE 1

| Temperature | Mean | Standard deviation |
|---|---|---|
| −40° C. | 1.219 V | 4.8 mV |
| 27° C. | 1.219 V | 6.45 mV |
| 85° C. | 1.218 V | 7.85 mV |

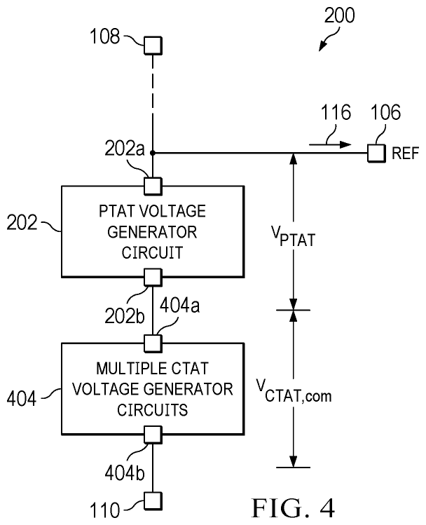

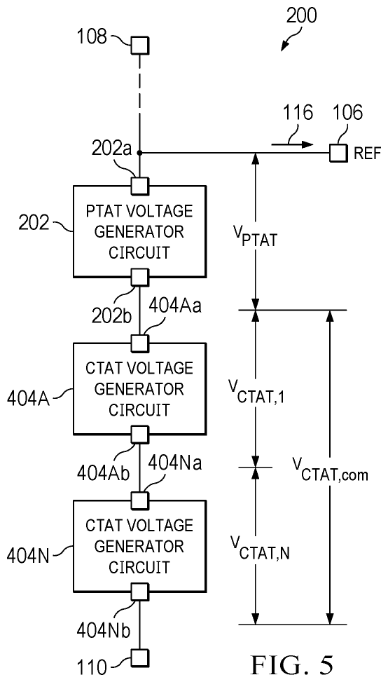

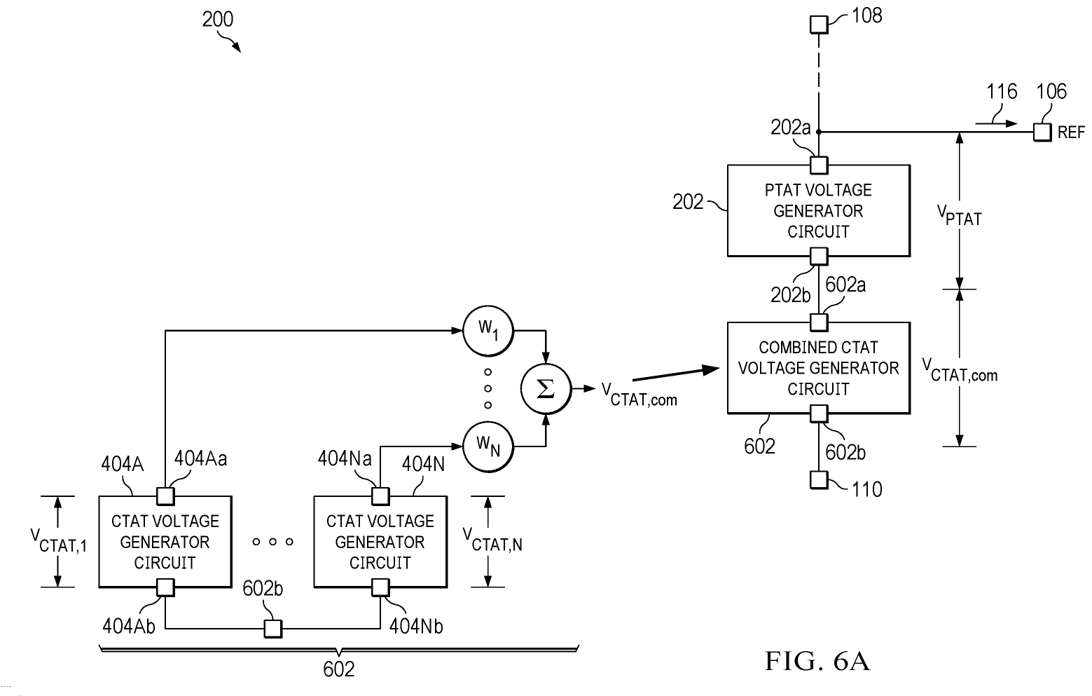

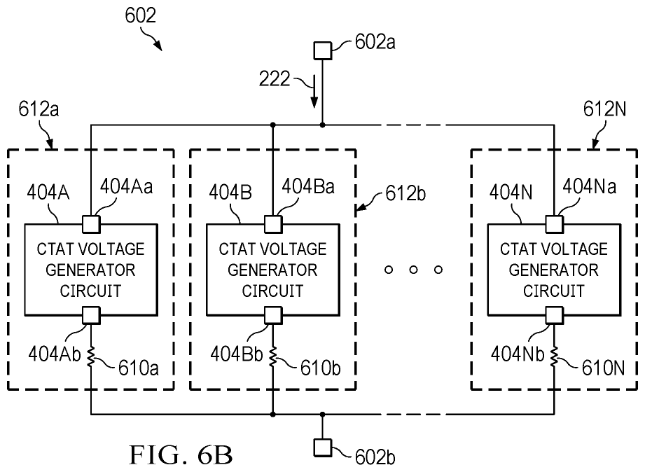

FIG. 4 illustrates an example of bandgap reference circuit 200 that can mitigate the variation of reference voltage 116 due to process variations. Referring to FIG. 4, bandgap reference circuit 200 can include PTAT voltage generator circuit 202 and multiple CTAT voltage generator circuits 404 coupled between reference voltage output 106 and ground terminal 110. PTAT voltage generator circuit 202 can generate a V_{PTAT} voltage. Also, each CTAT voltage generator circuit of CTAT voltage generator circuits 404 can generate a respective V_{CTAT} voltage, and the multiple CTAT voltage generator circuits 404 can generate a combined V_{CTAT,COM} voltage across terminals 404a and 404b. Bandgap reference circuit 200 can generate reference voltage output 106 based on a sum of V_{PTAT} voltage and the V_{CTAT,COM} voltage.

In some examples, CTAT voltage generator circuits 404 can include semiconductor junctions that are weakly correlated to each other so that their forward voltages or threshold V_{BE} voltages can have different dependencies on process. By generating a combined V_{CTAT,com} voltage that is a combination of the V_{CTAT} voltages provided by the CTAT voltage generator circuits, the different dependencies of the V_{CTAT} voltages on process can be averaged out in the combined V_{CTAT,COM} voltage, which in turn can reduce the variation of reference voltage 116 due to process variations

In some examples, these semiconductor junctions can have different doping profiles (e.g., each semiconductor junction can have a different N_{A}, N_{D}, D_{N}, D_{P}, L_{N}, and/or L_{P}) which can weaken the correlation among the semiconductor junctions compared with a case where the semiconductor junctions have the same doping profiles. The different doping profiles can be created due to, for example, the different doped regions forming the different semiconductor junctions are formed in different implantation operations, so that a particular deviation of a particular parameter (e.g., N_{A}) of one doped region of one semiconductor junction is less likely to appear in another doped regions of another semiconductor junction.

In some examples, these semiconductor junctions can also have different geometries (e.g., by having a different junction cross-sectional area), or different structures. These junctions can be formed in different fabrication steps (e.g., using different masks, and involving different implantation operations), which can also weaken the correlation between the semiconductor junctions compared with a case where the semiconductor junctions have the same geometry and/or structure. For example, in a case where the CTAT voltage generator circuits include BJTs, the CTAT voltage generator circuits can include BJTs of different types (e.g., NPN BJT in one CTAT voltage generator circuit, PNP BJT in another CTAT voltage generator circuit), BJTs of the same type but have different structures (e.g., a lateral BJT in one CTAT voltage generator circuit, and a vertical BJT in another CTAT voltage generator circuit), or BJTs having different junction cross section areas and are formed using separate masks and/or implantation processes.

FIG. 5, FIG. 6A, and FIG. 6B are schematics of internal components of bandgap reference circuit 200 of FIG. 4. Referring to FIG. 5, bandgap reference circuit 200 can include PTAT voltage generator circuit 202 and multiple weakly-correlated CTAT voltage generator circuits 404, such as CTAT voltage generator circuits 404A . . . 404N, coupled in series between reference voltage output 106 and ground terminal 110. PTAT voltage generator circuit 202 and CTAT voltage generator circuit 404A . . . 404N can be arranged in any order between reference voltage output 106 and ground terminal 110, and FIG. 5 illustrates one example order. PTAT voltage generator circuit 202 can generate a V_{PTAT} voltage across terminals 202a and 202b. CTAT voltage generator circuit 404A can generate a V_{CTAT,1} voltage across terminals 404Aa and 404Ab, and CTAT voltage generator circuit 404N can generate a V_{CTAT,N} voltage across terminals 404Na and 404Nb. Bandgap reference circuit 200 can generate reference voltage 116 (with respect to ground terminal 110) based on a sum of V_{PTAT} and V_{CTAT,com}, wherein V_{CTAT,com} is a sum of V_{CTAT,1} . . . . V_{CTAT,N} voltages, as follows:

$${V}_{116} = {V}_{PTAT} + {V}_{CTAT , c o m} = {V}_{PTAT} + {\sum }_{i = 1}^{N} {V}_{CTAT , i} \qquad ( Equation 3 )$$

The serial combination of CTAT voltage generator circuit 404A . . . 404N allows generation of a relatively large reference voltage 116 with reduced dependency on process (in addition to reduced temperature dependency). For simplicity, assuming that the semiconductor junctions of N CTAT voltage generator circuits 404A . . . 404N are uncorrelated, and each V_{CTAT,i} voltage has a standard deviation of σᵢ, the overall standard deviation of reference voltage 116, σ_{V}_{₁₁₆}, in the example of FIG. 4 can be as follows:

$${σ}_{{V}_{116}} = \sqrt{{\sum }_{i = 1}^{N} {σ}_{i}^{2}} \qquad ( Equation 4 )$$

As shown in Equation 4, σ_{V}_{₁₁₆} increases with \sqrt{N} for similar-valued σᵢ, whereas the expected value of V₁₁₆ (viz., [symbol] V₁₁₆ [symbol] ) increases with N. Therefore, the normalized deviation (i.e., σ_{V}_{₁₁₆}/ [symbol] V₁₁₆ [symbol] ) reduces by \sqrt{N} in a case where σᵢ is the same for each CTAT voltage generator.

Also, referring to FIG. 6A, bandgap reference circuit 200 can include PTAT voltage generator circuit 202 and multiple weakly-correlated CTAT voltage generator circuits, such as CTAT voltage generator circuits 404A . . . 404N. The multiple weakly-correlated CTAT voltage generator circuits 404A . . . 404N can be coupled in parallel forming a combined CTAT voltage generator circuit 602, where each of CTAT voltage generator circuits 404A . . . 404N are coupled in parallel between terminals 602a and 602b of combined CTAT voltage generator circuit 602. PTAT voltage generator circuit 202 and combined CTAT voltage generator circuit 602 can be coupled in series between reference voltage output 106 and ground terminal 110. PTAT voltage generator circuit 202 and combined CTAT voltage generator circuit 602 can be arranged in any order between reference voltage output 106 and ground terminal 110, and FIG. 6A illustrates one example order. CTAT voltage generator circuits 404A can generate a V_{CTAT,1} voltage across terminals 404Aa and 404Ab, and CTAT voltage generator circuits 404N can generate a V_{CTAT,N} voltage across terminals 404Na and 404Nb. Combined CTAT voltage generator circuit 602 can generate combined V_{CTAT,com} voltage based on a weighted average of the V_{CTAT} voltages provided by the respective CTAT voltage generator circuits, as follows:

$${V}_{116} = {V}_{PTAT} + {V}_{CTAT , c o m} = {V}_{PTAT} + {\sum }_{i = 1}^{N} ( {w}_{i} \times {V}_{CTAT , i} ) \qquad ( Equation 5 )$$

In Equation 5, wᵢ represents a weight for a specific V_{CTAT,i} voltage, and the sum of all wᵢ can be equal to one.

The parallel combination of CTAT voltage generator circuit 404A . . . 404N allows generation of a relatively small reference voltage 116 with reduced dependency on process (in addition to reduced temperature dependency). The parallel combination also allows bandgap reference circuit 200 to operate on a reduced power supply voltage. For simplicity, assuming that the semiconductor junctions of N CTAT voltage generator circuits 404A . . . 404N are uncorrelated, the weight w is the same for all N CTAT voltage generator circuits (e.g., w=1/N), and each V_{CTAT,i} voltage has a standard deviation of σᵢ, the overall standard deviation of reference voltage 116, σ_{V}_{₁₁₆}, in the example of FIG. 6A can be as follows:

$${σ}_{{V}_{116}} = \frac{1}{N} \sqrt{{\sum }_{i = 1}^{N} {σ}_{i}^{2}} \qquad ( Equation 6 )$$

As shown in Equation 6, σ_{V}_{₁₁₆} can be reduced with respect to the standard deviation σᵢ of each V_{CTAT,i} voltage by a factor of \sqrt{N}, for a case where σᵢ is the same for each CTAT voltage generator.

FIG. 6B illustrates examples of internal components of combined CTAT voltage generator circuit 602. As shown in FIG. 6B, combined CTAT voltage generator circuit 602 can include multiple circuit branches coupled in parallel between terminals 602a and 602b, with each circuit branch including a CTAT voltage generator circuit 404 and a resistor 610. For example, combined CTAT voltage generator circuit 602 can include a circuit branch 612a having CTAT voltage generator circuit 404A and resistor 610A, a second circuit branch having CTAT voltage generator circuit 404B and resistor 610B, and an N^{th} circuit branch having CTAT voltage generator circuit 404N and resistor 610N. Due to the parallel connection, the sum of the voltage across the resistor 610 and the V_{CTAT} voltage provided by the CTAT voltage generator circuit 404 of a circuit branch equals V_{CTAT,com} and is the same across all circuit branches. As described above, bandgap reference circuit 200 can receive a PTAT current 222 that flows through PTAT voltage generator circuit 202 to generate the V_{PTAT} voltage. PTAT current 222 also flows through combined CTAT voltage generator circuit 602 and is split between the circuit branches. The resistance of resistor 610 in each branch can set the amount of PTAT current through the circuit branch, which can reduce the negative temperature dependence of the total voltage across the circuit branch. Accordingly, the resistance of resistor 610 of a particular branch can set the weight wi for the CTAT voltage generator circuit 404 of that branch. In a case where the CTAT voltages are equally weighted, the resistor of each circuit branch can have the same resistance.

As described above, bandgap reference circuit 200 can include a current control feedback loop that senses the V_{CTAT} voltage difference between two CTAT devices that have different current densities, and the V_{CTAT} voltage difference is a function of a thermal voltage V_{T} that increases with temperature. The feedback loop can then adjust control signal 224 based on the sensed V_{CTAT} voltage difference to generate PTAT current 222, which can flow through PTAT voltage generator circuit 202 (e.g., a resistor) to generate a V_{PTAT} voltage.

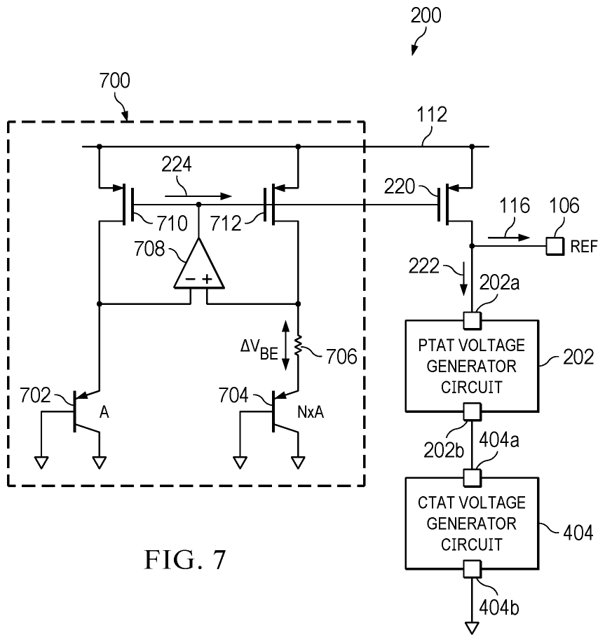

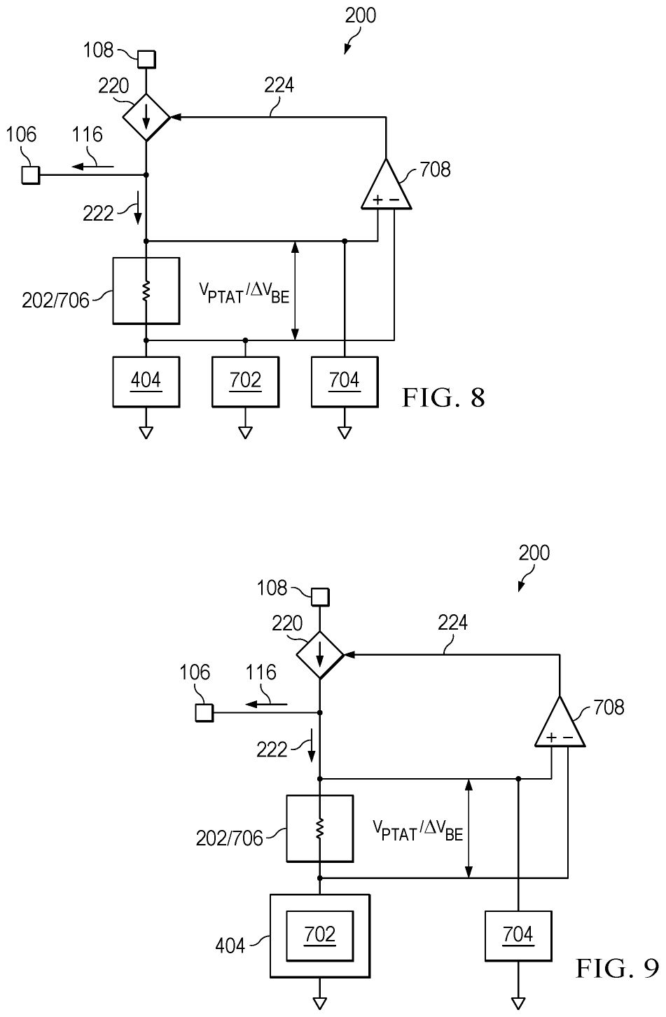

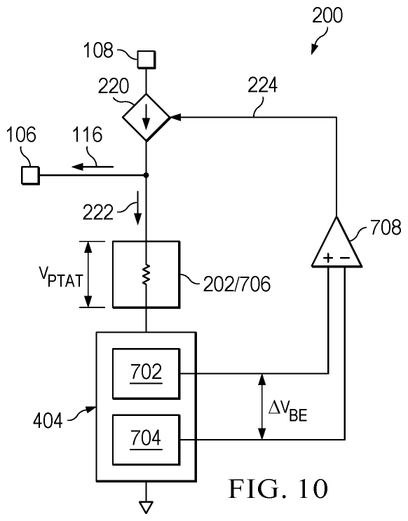

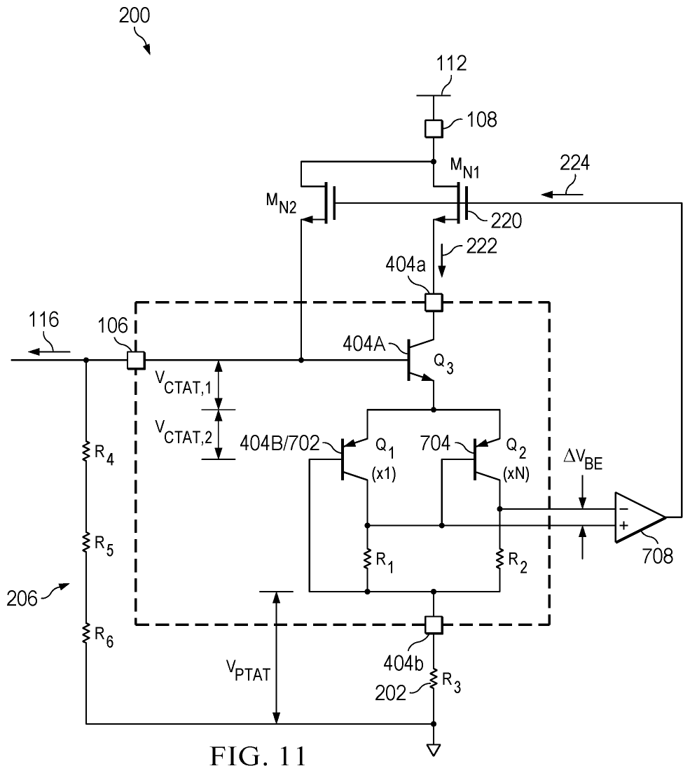

FIG. 7, FIG. 8, FIG. 9, and FIG. 10 are schematics that illustrate example current control circuits that implements the current control feedback loop. Referring to FIG. 7, current control circuit 700 can include CTAT voltage generator circuits 702 and 704, which are configured to have relatively high correlation (e.g., having the same doping profiles and being matched). Each of CTAT voltage generator circuits 702 and 704 can include a diode or, as shown in FIG. 7, a diode-connected BJT with base and collector coupled together to form a cathode and the emitter forms an anode. The emitter areas of CTAT voltage generator circuits 702 and 704 can have a ratio of 1:N different emitter areas, so that CTAT voltage generator circuit 704 has 1/N the current density compared with CTAT voltage generator circuit 702. The different current densities can lead to a V_{CTAT} voltage difference between CTAT voltage generator circuits 702 and 704 represented, and the V_{CTAT} voltage difference can be represented by ΔV_{BE} between the BJTs. If CTAT voltage generator circuits 702 and 704 are strongly-correlated (e.g., having the same doping profiles, same device geometry, and same device structure) so that the V_{CTAT} voltages provided by CTAT voltage generator circuits 702 and 704 have the same dependency on temperature, ΔV_{BE} can be related to a thermal voltage V_{T} and N as follows:

$$Δ {V}_{B E} = {V}_{T} ln ( N ) = \frac{k T}{q} ln ( N ) \qquad ( Equation 7 )$$

In Equation 7, thermal voltage V_{T} equals kT/q, where q represents the elementary charge constant, k represents the Boltzmann's constant, T represents the absolute temperature, and ΔV_{BE} increases with temperature.

Current control circuit 700 can generate PTAT current 222 by sensing ΔV_{BE}. Specifically, current control circuit 700 includes a resistor 706 having one end coupled to the emitter/anode of CTAT voltage generator circuit 704. The voltage across resistor 706 can represent ΔV_{BE}. Current control circuit 700 also includes an amplifier 708 having first and second inputs and an output. The first input of amplifier 708 can be coupled to the emitter/anode of CTAT voltage generator circuit 702, the second input of amplifier 708 can be coupled to another end of resistor 706, and amplifier 708 can generate control signal 224 based on amplifying ΔV_{BE}. Current control circuit 700 also includes variable current sources 710, 712, and 220 each controlled by control signal 224. Current sources 710 and 712 can have a ratio of 1:1 to provide equal currents to CTAT voltage generator circuit 704 and CTAT voltage generator circuit 702, and current source 220 can provide PTAT current 222 responsive to control signal 224. As ΔV_{BE} increases with temperature, current control circuit 700 can adjust control signal 224 and increase PTAT current 222, so that PTAT current 222 also increases with temperature.

In the example shown in FIG. 7, CTAT voltage generator circuits 702 and 704 and resistor 706 are external to bandgap reference circuit 200. In some examples, one or more CTAT voltage generator circuits 702 and 704 and resistor 706 can be part of bandgap reference circuit 200. FIG. 8 and FIG. 9 illustrate examples of current control circuit 700 in which one or more CTAT voltage generator circuits 702 and 704 and resistor 706 are part of bandgap reference circuit 200. Referring to FIG. 8, resistor 706 can be part of PTAT voltage generator circuit 202, and the feedback loop can generate control signal 224 by sensing and adjusting the V_{PTAT} voltage across PTAT voltage generator circuit 202 to be equal to ΔV_{BE} between CTAT voltage generator circuits 702 and 704. Such arrangements can reduce the impact of mismatch between resistor 706 and PTAT voltage generator circuit 202 (if resistor 706 is not part of PTAT voltage generator circuit 202) on the V_{PTAT} voltage, and the accuracy of the feedback loop in adjusting the V_{PTAT} voltage to track the ΔV_{BE} and the temperature of bandgap reference circuit 200 can be improved.

Also, in FIG. 9, CTAT voltage generator circuit 702 can be part of multiple CTAT voltage generator circuits 404 and can conduct part of PTAT current 222, and in FIG. 10, CTAT voltage generator circuit 704 can also be part of the multiple CTAT voltage generator circuits 404, and amplifier 708 can sense the ΔV_{BE} between CTAT voltage generator circuits 702 and 704 within the multiple CTAT voltage generator circuits 404. In both examples, CTAT voltage generator circuit 702 can be weakly-correlated to other CTAT voltage generator circuits 404 (e.g., by having different doping profiles and/or device geometries/structures) but strongly-correlated to CTAT voltage generator circuit 704 (e.g., by having the same doping profiles, same device geometry, and same device structure). Such arrangements allow the V_{PTAT} voltage to also track process variation of the multiple CTAT voltage generator circuits 404, which can further reduce the variation of reference voltage 116 with respect to temperature and process variations.

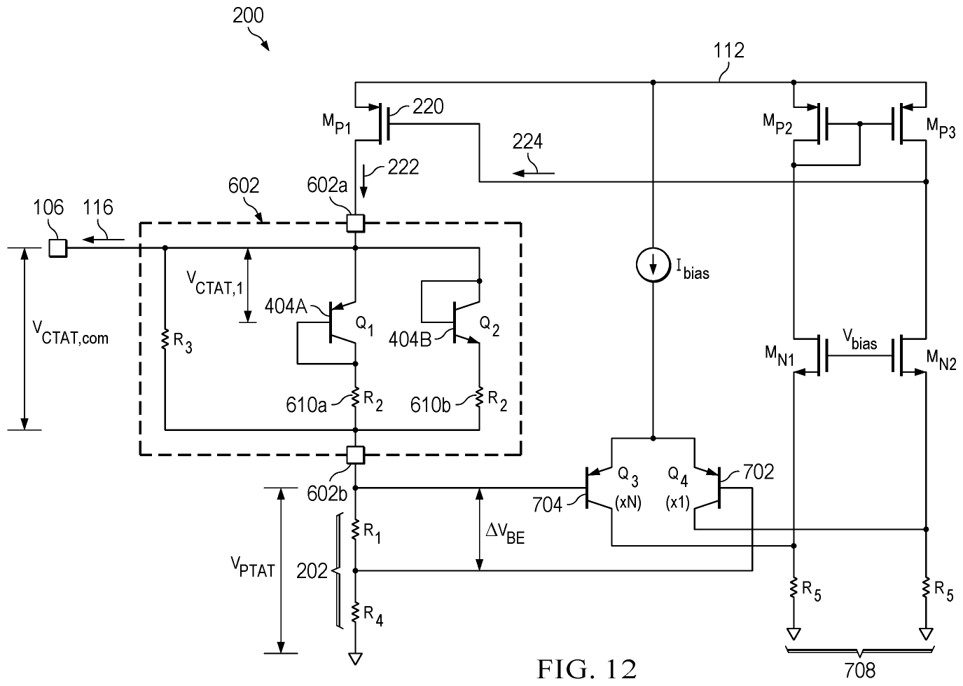

FIG. 11, FIG. 12, and FIG. 13 are schematics that illustrate additional examples of bandgap reference circuit 200. The bandgap reference circuit 200 of FIG. 11 can be an example of bandgap reference circuit 200 of FIG. 5 where multiple CTAT voltage generator circuits 404 are coupled in series, and bandgap reference circuit 200 generates the combined V_{CTAT,com} voltage based on a sum of the V_{CTAT} voltages of the multiple CTAT voltage generator circuits 404. In FIG. 11, BJT Q3 can represent CTAT voltage generator circuit 404A, and BJT Q1 can represent CTAT voltage generator circuit 404B. The semiconductor junctions of Q1 and Q3 (between base and emitter) can be serially connected between reference voltage output 106 and the ground terminal. Q3 provides a V_{CTAT,1} voltage representing the V_{BE} of Q3, and Q1 provides a V_{CTAT,2} voltage representing the V_{EB} of Q1. In the example of FIGS. 10, Q1 and Q3 can be weakly-correlated due to being of different types of BJTs (NPN for Q3, PNP for Q1). In some other examples, Q1 and Q3 can be of the same type of BJTs (e.g., both NPN or PNP) and can be made weakly-correlated by, for example, having different doping profiles, different device geometries (and formed using different masks), different device structures (e.g., lateral versus vertical BJTs), etc.

Bandgap reference circuit 200 also includes resistor R3 coupled between the multiple CTAT voltage generator circuits 404 and the ground, and resistor R3 represents PTAT voltage generator circuit 202. The multiple CTAT voltage generator circuits 404 receives PTAT current 222 from variable current source 220 (represented by transistor M_{N1}) via terminal 404a, and provide PTAT current 222 to resistor R3 via terminal 404b. Resistor R3 can provide a V_{PTAT} voltage responsive to PTAT current 222. Accordingly, reference voltage 116 can be based on a sum of V_{PTAT}, V_{CTAT,1}, and V_{CTAT,2} with reference to ground.

Also, the example bandgap reference circuit 200 includes current control circuit 700 that implements a current control feedback loop to provide PTAT current 222. Current control circuit 700 includes CTAT voltage generator circuit 404B (as CTAT voltage generator circuit 702) and CTAT voltage generator circuit 704 (BJT Q2) that share/split PTAT current 222. Bandgap reference circuit 200 also includes a resistor R1 coupled between collector of Q1 and terminal 404b, and a resistor R2 coupled between collector of Q2 and terminal 404b. The difference in the current densities between Q1 and Q2 can lead to a difference in the voltages across R1 and R2, and the voltage difference represents a ΔV_{BE} between Q1 and Q2, which increases with temperature as described above. Current control circuit 700 also includes amplifier 708 to generate control signal 224 by amplifying ΔV_{BE}, so that PTAT current 222 provided by variable current source 220 increases with temperature. The current control feedback loop of FIG. 11 can be an example of the one shown in FIG. 10 where the CTAT voltage generator circuits that provide ΔV_{BE} are part of the multiple CTAT voltage generator circuits 404 and conducts part of the PTAT current, which allows the V_{PTAT} voltage to also track process variation of the multiple CTAT voltage generator circuits 404 and can further reduce the variation of reference voltage 116 with respect to temperature and process variations.

The example bandgap reference circuit 200 of FIG. 10 also includes additional components. For example, bandgap reference circuit 200 may include a transistor M_{N2} coupled between terminal 108 (and power source 112) and reference voltage output 106 (and base of Q3), with the control terminal of transistor M_{N2} coupled to the control terminal of variable current source 220 to receive control signal 224. Transistor M_{N2} can be a startup circuit to bring up the voltage of the base of Q3 and to conduct PTAT current 222. In some examples, Q3 can be diode-connected with base and collector coupled together, and transistor M_{N2} can be omitted. Also, bandgap reference circuit 200 can include voltage scaling circuit 206 including a resistive divider coupled between reference voltage output 106 and the ground to generate scaled version of reference voltage 116.

The following equation describes a relationship between reference voltage 116 and V_{CTAT} and V_{PTAT} voltages in FIG. 11, for a case where R1 and R2 are equal:

$${V}_{116} = {V}_{E B 1} + {V}_{B E 3} + 2 {V}_{t} ln ( N ) ( \frac{{R}_{3}}{{R}_{1}} ) \qquad ( Equation 8 )$$

In Equation 8, V_{EB1} is the V_{CTAT} voltage provided by PNP Q1, V_{BE3} is the V_{CTAT} voltage provided by the NPN Q3, and the 2Vₜ ln(N) (R₃/R₁) term represents the V_{PTAT} voltage generated based on the ΔV_{BE} between Q1 and Q2 due to them having the N:1 current density ratio, and the ΔV_{BE} is scaled by the resistances of R₁ and R₃ in Equation 8.

FIG. 12 illustrates another example of bandgap reference circuit 200. The bandgap reference circuit 200 of FIG. 12 can be an example of bandgap reference circuit 200 of FIGS. 6A and 6B where multiple CTAT voltage generator circuits 404 are coupled in parallel forming a combined CTAT voltage generator circuit 602, and bandgap reference circuit 200 generates the combined V_{CTAT,com} voltage based on a weighted sum of the V_{CTAT} voltages of the multiple CTAT voltage generator circuits 404. In FIG. 12, BJT Q1 can represent CTAT voltage generator circuit 404A, and BJT Q2 can represent CTAT voltage generator circuit 404B. The semiconductor junctions of Q1 and Q2 (between base and emitter) can be coupled in different circuit branches (and in parallel) between terminals 602a and 602b. Each of Q1 and Q2 is diode-connected, with Q1 providing a V_{CTAT,1} voltage representing the V_{EB} of Q1, and Q2 providing a V_{CTAT,2} voltage representing the V_{BE} of Q2. Q1 and Q2 can be weakly-correlated due to being of different types of BJTs (NPN for Q3, PNP for Q1). In some other examples, Q1 and Q2 can be of the same type of BJTs (e.g., both NPN or PNP) and can be made weakly-correlated by, for example, having different doping profiles, different device geometries (and formed using different masks), different device structures (e.g., lateral versus vertical BJTs), etc.

Combined CTAT voltage generator circuit 602 also include resistor 610a coupled in series with CTAT voltage generator circuit 404A and resistor 610b coupled in series with CTAT voltage generator circuit 404B. As described above, resistors 610a and 610b can set the weights of the V_{CTAT} voltage provided by CTAT voltage generator circuits 404A and 404B in the combined V_{CTAT} voltage V_{CTAT,com}. In the example of FIG. 12, both resistors 610a and 610b can have the same resistance, and the V_{CTAT,1} and V_{CTAT,2} voltage 2 can be equally weighted in V_{CTAT,com}. In some examples, combined CTAT voltage generator circuit 602 also includes a resistor R3 coupled between terminals 602a and 602b as a voltage divider to further scale down reference voltage 116 to a lower value to support a low voltage application.

Bandgap reference circuit 200 also includes resistors R1 and R4 coupled in series between terminal 602b of combined CTAT voltage generator circuit 602 and ground. Resistors R1 and R4 can represent PTAT voltage generator circuit 202. Combined CTAT voltage generator circuit 602 receives PTAT current 222 from variable current source 220 (represented by transistor M_{P1}) via terminal 602a, and provide PTAT current 222 to resistor R1 and R4 via terminal 602b. Resistors R1 and R4 can provide a V_{PTAT} voltage responsive to PTAT current 222. Accordingly, reference voltage 116 can be based on a sum of V_{PTAT} and V_{CTAT,com} with reference to ground.

Also, the example bandgap reference circuit 200 includes current control circuit 700 that implements a current control feedback loop to provide PTAT current 222. Current control circuit 700 includes CTAT voltage generator circuits 702 (BJT Q4) and 704 (BJT Q3). Q3 and Q4 has a current density ratio of 1:N, which give rises to ΔV_{BE} between the transistors. Current control circuit 700 also includes amplifier 708 having inputs coupled to the collectors of Q3 and Q4 and an output coupled to variable current source 220 to provide control signal 224. The bases of Q3 and Q4 are coupled between resistor R1 of PTAT voltage generator circuit 202, and the current control feedback loop can adjust PTAT current 222 (by adjusting control signal 224) so that the voltage across resistor R1 tracks the ΔV_{BE} between the transistors, which increases with temperature, so that PTAT current 222 also increases with temperature. The current control feedback loop of FIG. 12 can be an example of the one shown in FIG. 8 where the feedback loop generates control signal 224 by sensing and adjusting the V_{PTAT} voltage across PTAT voltage generator circuit 202 to be equal to ΔV_{BE}, which can improve the accuracy of the feedback loop in adjusting the V_{PTAT} voltage to track the temperature of bandgap reference circuit 200.

The following equation describes a relationship between reference voltage 116 and V_{CTAT} and V_{PTAT} voltages in FIG. 12:

$${V}_{116} = \frac{{V}_{t} ln ( N )}{{R}_{1}} [ ( {R}_{3} ‖ {R}_{2} / 2 ) + {R}_{1} + {R}_{4} ] + ( {V}_{E B 1} + {V}_{B E 2} ) ( \frac{{R}_{3} ‖ {R}_{2}}{{R}_{3} ‖ {R}_{2} + {R}_{2}} ) \qquad ( Equation 9 )$$

In Equation 9, V_{EB1} is the V_{CTAT} voltage provided by PNP Q1, V_{BE2} is the V_{CTAT} voltage provided by the NPN Q2, and the term (V_{EB1}+V_{BE2}) (R₃∥R₂/R₃∥R₂+R₂) represents V_{CTAT,com} voltage that is a weighted average of V_{EB1} and V_{BE2}. Also, the Vₜ ln(N)/R₁[(R₃∥R₂/2)+R₁+R₄] term represents the V_{PTAT} voltage generated based on the ΔV_{BE} between Q3 and Q4 due to them having a 1:N current density ratio. Both the V_{CTAT,com} and V_{PTAT} voltages are scaled down by the resistance of resistor R3 to provide a reduced reference voltage 116.

FIG. 13 illustrates another example of bandgap reference circuit 200. The bandgap reference circuit 200 of FIG. 13 can be another example of bandgap reference circuit 200 of FIGS. 6A and 6B where multiple CTAT voltage generator circuits 404 are coupled in parallel forming a combined CTAT voltage generator circuit 602, and bandgap reference circuit 200 generates the combined V_{CTAT,com} voltage based on a weighted sum of the V_{CTAT} voltages of the multiple CTAT voltage generator circuits 404. In FIG. 13, BJT Q1 can represent CTAT voltage generator circuit 404A, and BJT Q2 can represent CTAT voltage generator circuit 404B. The semiconductor junctions of Q1 and Q2 (between base and emitter) can be coupled in different circuit branches (and in parallel) between terminals 602a and 602b. Each of Q1 and Q2 is diode-connected, with Q1 providing a V_{CTAT,1} voltage representing the V_{BE} of Q1, and Q2 providing a V_{CTAT,2} voltage representing the V_{EB} of Q2. Q1 and Q2 can be weakly-correlated due to being of different types of BJTs (NPN for Q3, PNP for Q1). In some other examples, Q1 and Q2 can be of the same type of BJTs (e.g., both NPN or PNP) and can be made weakly-correlated by, for example, having different doping profiles, different device geometries (and formed using different masks), different device structures (e.g., lateral versus vertical BJTs), etc.

Combined CTAT voltage generator circuit 602 also include resistor 610a (represented by resistor R2) coupled in series with CTAT voltage generator circuit 404A and resistor 610b (represented by resistor R7) coupled in series with CTAT voltage generator circuit 404B. As described above, resistors 610a and 610b can set the weights of the V_{CTAT} voltage provided by CTAT voltage generator circuits 404A and 404B in the combined V_{CTAT} voltage V_{CTAT,com}. In some examples, combined CTAT voltage generator circuit 602 also includes resistors R3, R4, and R5 coupled in series between terminals 602a and 602b as a voltage divider to further scale down reference voltage 116 to a lower value to support a low voltage application. A second reference voltage output 208 can be tapped off between resistors R₃, R₄, and R₅ to provide reference voltage 210 as a further scaled down version of reference voltage 116.

Bandgap reference circuit 200 also includes resistors R1 coupled in series between variable current source 220 (represented by transistor M_{P1}) and terminal 602a of combined CTAT voltage generator circuit 602. Resistor R1 can represent PTAT voltage generator circuit 202. Resistor R1 receives PTAT current 222 from variable current source 220 and provide PTAT current 222 to combined CTAT voltage generator circuit 602 via terminal 602a. Resistor R1 can provide a V_{PTAT} voltage responsive to PTAT current 222. Accordingly, reference voltage 116 can be based on a sum of V_{PTAT} and V_{CTAT,com} with reference to ground.

Also, the example bandgap reference circuit 200 includes current control circuit 700 that implements a current control feedback loop to provide PTAT current 222. Current control circuit 700 includes CTAT voltage generator circuits 404B/704 (BJT Q2) and 702 (BJT Q3). Q2 and Q3 has a current density ratio of 1:N, which give rises to ΔV_{BE} between the transistors. Current control circuit 700 also includes amplifier 708 having inputs coupled to the collectors of Q2 and Q3 and an output coupled to variable current source 220 to provide control signal 224. The emitters of Q2 and Q3 are coupled between resistor R1 of PTAT voltage generator circuit 202, and the current control feedback loop can adjust PTAT current 222 (by adjusting control signal 224) so that the voltage across resistor R1 tracks the ΔV_{BE} between the transistors, which increases with temperature, so that PTAT current 222 also increases with temperature. Bandgap reference circuit 200 also includes transistor MN5 and MN6 to provide a startup circuit.

The current control feedback loop of FIG. 12 can be an example of the one shown in FIG. 9 where the feedback loop generates control signal 224 by sensing and adjusting the V_{PTAT} voltage across PTAT voltage generator circuit 202 to be equal to ΔV_{BE}, and CTAT voltage generator circuit 702 can be part of multiple CTAT voltage generator circuits 404 and can conduct part of PTAT current 222, which can improve the accuracy of the feedback loop in adjusting the V_{PTAT} voltage to track the temperature of bandgap reference circuit 200 and the process variations of combined CTAT voltage generator circuit 602.

The following equation describes a relationship between reference voltage 116 and V_{CTAT} and V_{PTAT} voltages in FIG. 12:

$${V}_{116} = \frac{{V}_{t} ln ( N )}{{R}_{1}} ( {R}_{P} ‖ {R}_{2} ‖ {R}_{7} ) + {V}_{B E 1} ( \frac{{R}_{P} ‖ {R}_{7}}{{R}_{P} ‖ {R}_{7} + {R}_{2}} ) + {V}_{B E 2} ( \frac{{R}_{P} ‖ {R}_{2}}{{R}_{P} ‖ {R}_{2} + {R}_{7}} ) \qquad ( Equation 10 )$$

In Equation 10, V_{BE1} is the V_{CTAT} voltage provided by NPN Q1, V_{EB2} is the V_{CTAT} voltage provided by the PNP Q2, and the term V_{BE1} (R_{P}∥R₇/R_{P}∥R₇+R₂)+V_{BE2} (R_{P}∥R₂/R_{P}∥R₂+R₇) represents V_{CTAT,com} voltage that is a weighted average of V_{BE1} and V_{EB2}. Also, the Vₜ ln(N)/R₁ (R_{P}∥R₂∥R₇) term represents the V_{PTAT} voltage generated based on the ΔV_{BE} between Q2 and Q3 due to them having the 1:N current density ratio. Both the V_{CTAT,com} and V_{PTAT} voltages are scaled down by the resistance of resistor R3, R4, and R5, with a sum of the resistances represented by R_{P}, to provide a reduced reference voltage 116. Further, as described above, second reference voltage output 208 can be tapped off between resistors R₃, R₄, and R₅ to provide reference voltage 210 as a further scaled down version of the reduced reference voltage 116.

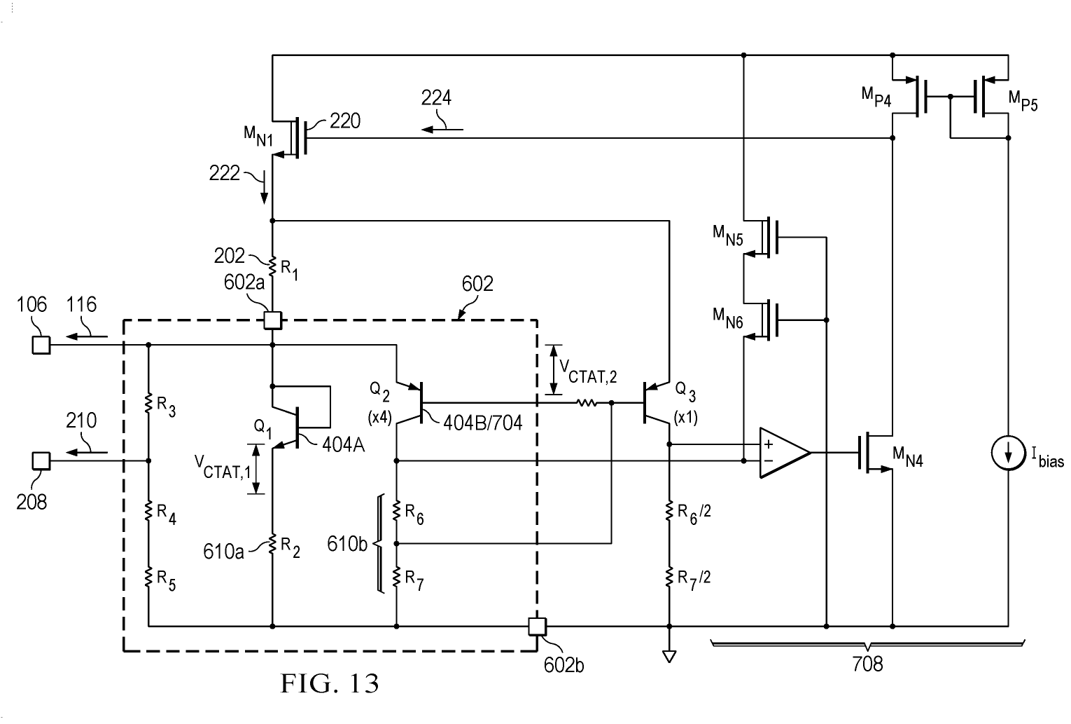

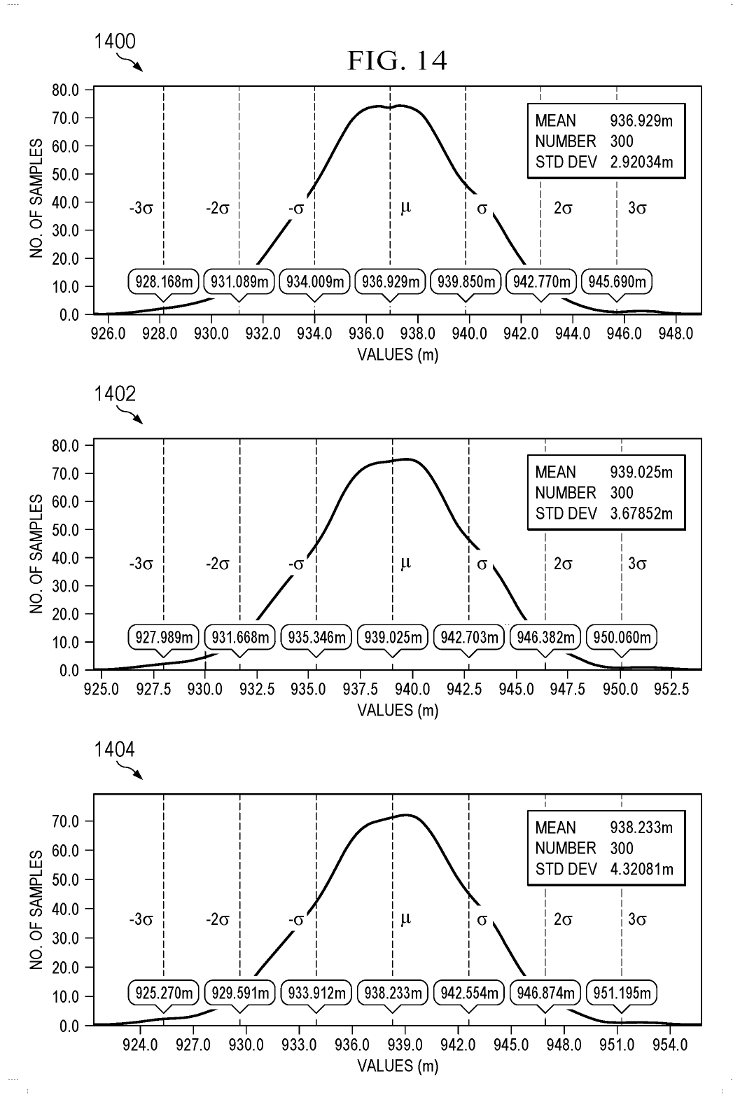

FIG. 14 includes graphs representing example distributions of reference voltage 116 provided by the example bandgap reference circuit 200 of FIG. 12 with random process variations. Graphs 1400, 1402 and 1404 illustrate example distributions of reference voltage 116 with bandgap reference circuit 200 operating at, respectively, −40° C., 27° C., and 85° C. Graphs 1400, 1402 and 1404 are obtained from simulation of three hundred instances of bandgap reference circuit 200. The following table provides a summary of the mean and standard deviation of reference voltage 116 for each temperature. The standard deviation is between 0.3%-0.5% of the mean reference voltage 116.

TABLE 2

| | | |
|---|---|---|
| Temperature | Mean | Standard deviation |

| | | | |
|---|---|---|---|
| −40° C. | 936.93 | mV | 2.92 mV |
| 27° C. | 939 | mV | 3.68 mV |
| 85° C. | 938.23 | mV | 4.32 mV |

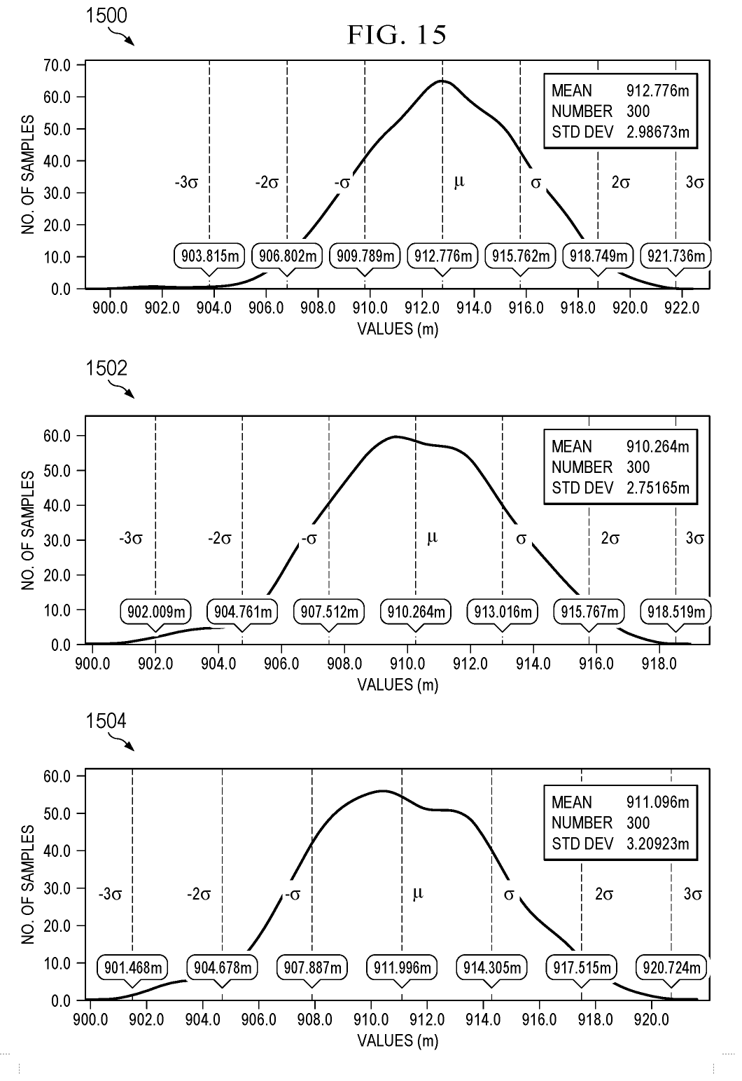

FIG. 15 includes graphs representing example distributions of reference voltage 116 provided by the example bandgap reference circuit 200 of FIG. 13 with random process variations. Graphs 1500, 1502 and 1504 illustrate example distributions of reference voltage 116 with bandgap reference circuit 200 operating at, respectively, −40° C., 27° C., and 85° C. Graphs 1500, 1502 and 1504 are obtained from simulation of three hundred instances of bandgap reference circuit 200. The following table provides a summary of the mean and standard deviation of reference voltage 116 for each temperature. The standard deviation is between 0.3%-0.4% of the mean reference voltage 116.

TABLE 3

| Temperature | Mean | Standard deviation |
|---|---|---|
| −40° C. | 912.78 mV | 2.99 mV |
| 27° C. | 910.26 mV | 2.75 mV |
| 85° C. | 911.1 mV | 3.21 mV |

In this description, the term “couple” may cover connections, communications or signal paths that enable a functional relationship consistent with this description. Accordingly, if device A generates a signal to control device B to perform an action, then: (a) in a first example, device A is coupled directly to device B; or (b) in a second example, device A is coupled to device B through intervening component C if intervening component C does not substantially alter the functional relationship between device A and device B, so device B is controlled by device A via the control signal generated by device A.

A device “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors are described herein, other transistors (or equivalent devices) may be used instead with little or no change to the remaining circuitry. For example, a metal-oxide-silicon FET (“MOSFET”) (such as an n-channel MOSFET, nMOSFET, or a p-channel MOSFET, pMOSFET), a bipolar junction transistor (BJT—e.g. NPN or PNP), insulated gate bipolar transistors (IGBTs), and/or junction field effect transistor (JFET) may be used in place of or in conjunction with the devices described herein. The transistors may be depletion mode devices, drain-extended devices, enhancement mode devices, natural transistors or other type of device structure transistors. Furthermore, the devices may be implemented in/over a silicon substrate (Si), a silicon carbide substrate (SiC), a gallium nitride substrate (GaN) or a gallium arsenide substrate (GaAs).

While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. Unless otherwise stated, “about,” “approximately,” or “substantially” preceding a value means within +/−10 percent of the stated value, or, if the value is zero, a reasonable range of values around zero. Modifications are possible in the described examples, and other implementations are possible, within the scope of the claims.

What is claimed is:

1. An apparatus comprising:
a voltage reference circuit having a voltage reference terminal and including a first circuit, a first semiconductor junction device, and a second semiconductor junction device coupled between the voltage reference terminal and a ground terminal, in which:
the first circuit is configured to generate a first voltage that increases with a temperature;
the first semiconductor junction device is configured to generate a second voltage that decreases with the temperature;
the second semiconductor junction device is configured to generate a third voltage that decreases with the temperature; and
the voltage reference circuit is configured to generate a fourth voltage between the voltage reference terminal and the ground terminal based on a sum of the first voltage and a combination of the second and third voltages.

2. The apparatus of claim 1, wherein the voltage reference circuit is configured to generate the fourth voltage based on a sum of the first, second, and third voltages.

3. The apparatus of claim 1, wherein the voltage reference circuit is configured to generate the fourth voltage based on a sum of the first voltage and a weighted average of the second and third voltages.

4. The apparatus of claim 1, wherein the first semiconductor junction device and the second semiconductor junction device have different doping profiles.

5. The apparatus of claim 1, wherein the voltage reference circuit includes a first bipolar junction transistor (BJT) and a second BJT, the first BJT including the first semiconductor junction device, and the second BJT including the second semiconductor junction device.

6. The apparatus of claim 5, wherein the first BJT is an NPN BJT, and the second BJT is a PNP BJT.

7. The apparatus of claim 5, wherein the first BJT is a vertical BJT, and the second BJT is a lateral BJT.

8. The apparatus of claim 1, wherein the first circuit has first terminals and includes a resistor coupled between the first terminals, the resistor configured to generate the first voltage between the first terminals responsive to a current that increases with the temperature.

9. The apparatus of claim 8, wherein the resistor is a first resistor, and the apparatus further comprises:
a variable current source having a current control input and a current output, the current output coupled to one of the first terminals; and
a current control circuit having a first control input, a second control input, and a current control output, the current control output coupled to the current control input;
a third semiconductor junction device coupled between the first control input and the ground terminal;
a fourth semiconductor junction device coupled between the second control input and the ground terminal, the fourth semiconductor junction device configured to conduct a larger current than the third semiconductor junction device; and
a second resistor coupled between the second control input and the fourth semiconductor junction device.

10. The apparatus of claim 8, further comprising:
a variable current source having a current control input and a current output, the current output coupled to one of the first terminals; and
a current control circuit having a control input and a current control output, the current control output coupled to the current control input, and the control input coupled to one of the first or second semiconductor junction devices.

11. The apparatus of claim 10, wherein the control input is a first control input, and the current control circuit have a second control input, the first control input coupled to a first one of the first terminals, and the second control input coupled to a second one of the first terminals.

12. The apparatus of claim 1, further comprising:
a current generation circuit having a current control input and a current output;
a first BJT having a first base and first current terminals, the first base coupled to the voltage reference terminal, a first one of the first current terminals coupled to the current output, and the first BJT including the first semiconductor junction device; and
a second BJT having a second base and second current terminals, a first one of the second current terminals coupled to a second one of the first current terminals, a second one of the second current terminals coupled to the second base, and the second BJT including the second semiconductor junction device.

13. The apparatus of claim 12, further comprising:
a third BJT having a third base and third current terminals, a first one of the third current terminals coupled to the second one of the first current terminals, the third base coupled to the second one of the second current terminals;
a first resistor coupled between the second one of the second current terminals and the second base;
a second resistor coupled between a second one of the third current terminals and the first resistor; and
a current control circuit having first and second control inputs and a current control output, the first control input coupled to the second one of the second current terminals, the second control input coupled to the second one of the third current terminals, and the current control output coupled to the current control input.

14. The apparatus of claim 1, further comprising:
a variable current source having a current control input and a current output;
a second circuit having second terminals, one of the second terminals coupled to the current output, and the second circuit including:
a first BJT and a first resistor coupled between the second terminals, the first BJT including the first semiconductor junction device; and
a second BJT and a second resistor coupled between the second terminals, the second BJT including the second semiconductor junction device.

15. The apparatus of claim 14, wherein:
the first BJT has a first base and first current terminals, the first base coupled to one of the first current terminals; and
the second BJT has a second base and second current terminals, the second base coupled to one of the second current terminals.

16. The apparatus of claim 14, further comprising a current control circuit having first and second control inputs and a current control output, the first and second control inputs coupled across the first circuit, and the current control output coupled to the current control input.

17. The apparatus of claim 16, wherein the current control circuit includes a third BJT having a third base and a fourth BJT having a fourth base, the third base coupled to the first control input, the fourth base coupled to the second control input, and the third BJT configured to conduct a larger current than the fourth BJT.

18. The apparatus of claim 15, wherein the first circuit includes a third resistor having a first resistor terminal coupled to the current output and a second resistor terminal coupled to a first one of the first current terminals and a first one of the second current terminals.

19. The apparatus of claim 18, further comprising:
a third BJT having a third base and third current terminals, the third base coupled to a second one of the first current terminals, and a first one of the third current terminal coupled to the first resistor terminal, the third BJT configured to conduct a different amount of current than the second BJT; and
a current control circuit having first and second control inputs and a current control output, the first control input coupled to a second one of the second current terminals, the second control input coupled to a second one of the third current terminals, and the current control output coupled to the current control input.

20. The apparatus of claim 14, further comprising a third resistor coupled between the second terminals.
